(19) United States
(12) Patent Application Publication
(10) Pub. No.: US 2009/0222316 A1
(43) Pub. Date: Sep. 3, 2009

(54) METHOD TO TAG ADVERTISER CAMPAIGNS TO ENABLE SEGMENTATION OF UNDERLYING INVENTORY

(75) Inventors: Raghav Boinepalli, Santa Clara, CA (US); Brad Smallwood, Palo Alto, CA (US); Madhu Vudali, Santa Clara, CA (US); Shi Zhong, Austin, TX (US)

Correspondence Address: MARTINE PENILLA & GENCARELLA, LLP, 710 LAKEWAY DRIVE, SUITE 200, SUNNYVALE, CA, 94085, US

(73) Assignee: Yahoo!, Inc., Sunnyvale, CA (US)

(21) Appl. No.: 12/039,566

(22) Filed: Feb. 28, 2008

(51) Int. Cl. G06Q 10/00; G06Q 30/00

(52) U.S. Cl. 705/10; 705/7; 705/14

(57) ABSTRACT

A method and system for enabling segmentation of advertising inventory for an advertisement campaign includes capturing a plurality of requirements for an advertisement campaign. The campaign requirements include a descriptive tag that uniquely identifies the advertisement campaign. The requirements include a plurality of campaign attributes that define the requirements of the advertisement campaign including target audience and advertisement campaign objective. A tag inventory, with a plurality of descriptive tags and a plurality of advertisement bookings associated with one or more of the descriptive tags, is analyzed based on the captured advertisement campaign requirements. A recommended suggestion of bookings based on the analysis is presented. The recommended suggestion of bookings matches at least a portion of the campaign attributes. A media plan is finalized for the advertisement campaign based on a response received for the recommended suggestion of bookings, the response defines the relevancy of the recommended suggestion of bookings.

### BACKGROUND

1. Field of the Invention

The present invention relates to internet advertising, and more particularly, to providing optimized media plans to customers that maximizes use of available inventory.

2. Description of the Related Art

The computing industry has seen many advances in recent years, and such advances have produced a multitude of products and services on the internet. One of the services is online or internet advertising. With the proliferation of information available and due to availability and growing popularity of internet marketing, advertisers have resorted to internet advertising for marketing their products or services. Internet advertising provides a number of advantages over traditional methods of advertising. For an advertiser, Internet advertising gives the opportunity to precisely target their audience, customizing the advertisements to each consumer's geographical region, interest, preference, taste, etc. Internet marketing is a great marketing tool as it provides low cost advertising and greater flexibility in reaching out to a global audience. Further, it is easier for an advertiser to analyze the effectiveness of an advertisement by tracking user interaction with their advertisements. For a consumer, Internet advertising provides more direct interaction and provides easy access to various products and services.

Typically in online advertisements, advertisers use one or more host servers as platforms to reach out to consumers and to communicate relevant messages. The host servers have a repository of advertisement inventory including target audience, web pages to place advertisement, etc. The knowledge and tools available at the host provides the scope that enables segmenting of the target audience and connecting the segmented audiences to the appropriate advertisers' products. This ability to segment the audience allows a host to serve both the advertisers and consumers effectively. The tools available at the host render the host's perspective of how to perform the segmentation. Perceptions being relative, the host perception and classification of the audience and advertising inventory may be different from how an advertiser perceives and classifies. The available tools lack the ability to accommodate advertisers' perception while performing the segmentation of the underlying advertising inventory to generate a media plan for the advertiser.

Media plans are generated by Sales Planners associated with host servers using tools available at the host server. An advertiser communicates his/her campaign requirements to a Sales Planner and the Sales Planner uses a laborious manual process to match the advertiser's requirement with the underlying inventory. Due to the high volume of campaigns and the labor intensive process involved, it is very difficult for a Sales Planner to research and match relevant data. The process is exacerbated by the limited expertise of the Sales Planner and lack of a single source for the relevant data. As a result, the media plan may end up including few popular products thereby under utilizing and under-monetizing large pockets of the available inventory. The suggested media plan is not only inefficient from an inventory usage perspective but also not sustainable due to pricing and other constraints placed on popular products.

Additionally, the existing tools do not provide the ability for an advertiser to provide his/her requirements for segmentation of underlying inventory. The proposed recommendation for the underlying inventory, therefore, may not provide an optimal solution to an advertiser to market his/her products.

It is in this context that embodiments of the invention arise.

### SUMMARY

Embodiments of the present invention provide methods and computer implemented systems that enable segmentation of advertising inventory for an advertisement campaign based on campaign requirements. A tag inventory is analyzed based on descriptive tag and campaign attributes that define the campaign requirements and a media plan is generated based on the analysis which meets the objective of the advertisement campaign. The generated media plan makes optimal use of the available tag inventory.

It should be appreciated that the present invention can be implemented in numerous ways, such as a process, an apparatus, a system, a device or a method. Several inventive embodiments of the present invention are described below.

In one embodiment, a method for enabling segmentation of advertising inventory for an advertisement campaign is disclosed. The method includes capturing a plurality of requirements for an advertisement campaign. The plurality of requirements includes a descriptive tag that uniquely identifies the advertisement campaign and a plurality of campaign attributes that define the requirements of the advertisement campaign including target audience and advertisement campaign objective. A tag inventory having a plurality of descriptive tags and a plurality of advertisement bookings associated with one or more of the descriptive tags is analyzed based on the captured advertisement campaign requirements. A recommended suggestion of bookings based on the analysis is presented. The recommended suggestion of bookings matches at least a portion of the campaign attributes. A media plan is finalized for the advertisement campaign based on a response received for the recommended suggestion of bookings, the response defines the relevancy of the recommended suggestion of bookings.

In another embodiment of the invention, a method for enabling segmentation of advertising inventory for an advertisement campaign is disclosed. The method includes receiving a descriptive tag that uniquely identifies the advertisement campaign. A tag inventory having a plurality of bookings associated with one or more descriptive tags is analyzed to identify a plurality of bookings associated with the received descriptive tag. A request for supporting data for each of the plurality of identified bookings is received. The supporting data provides validation information pertaining to the plurality of bookings. The identified plurality of bookings and the associated supporting data is presented in response to the descriptive tag. A media plan for the advertisement campaign is finalized based on a response received for the identified plurality of bookings presented. The response defines the relevancy of the identified plurality of bookings to the advertisement campaign.

In another embodiment of the invention, a system for enabling segmentation of advertising inventory for an advertisement campaign is provided. The system includes an user interface to receive and display a plurality of campaign requirements. The campaign requirements include a descriptive tag that uniquely identifies the advertisement campaign and a plurality of campaign attributes that define the campaign requirements including identifying a target audience and a campaign objective. The system further includes a proposal optimization tool on a server. The proposal optimization tool is communicatively connected to the user interface to capture the campaign requirements as a plurality of campaign attributes. The proposal optimization tool is further configured to analyze a tag inventory having a plurality of bookings based on the campaign requirements, present a recommended suggestion of bookings from the tag inventory that match at least a portion of the requirements and finalize a media plan from the recommended suggestion of bookings.

Other aspects of the invention will become apparent from the following detailed description, taken in conjunction with the accompanying drawings, illustrating by way of example the principles of the invention.

### BRIEF DESCRIPTION OF THE DRAWINGS

The invention may best be understood by reference to the following description taken in conjunction with the accompanying drawings.

FIG. 1 illustrates a typical inventory network associated with an advertising campaign, in accordance with one embodiment.

FIG. 2 illustrates a high level architecture of functional components in a system that enable segmentation of advertising inventory for an advertisement campaign, in accordance with one embodiment.

FIG. 3 illustrates a detailed schematic diagram of the functional components involved in the segmentation of advertising inventory for an advertisement campaign, in accordance with one embodiment.

FIG. 4 illustrates a flow chart of process operations involved in the segmentation of advertising inventory for an advertisement campaign, in accordance with one embodiment.

FIG. 5 illustrates a flow chart of process operations involved in the segmentation of advertising inventory for an advertisement campaign, in accordance with an alternate embodiment.

### DETAILED DESCRIPTION

Broadly speaking, the embodiments of the present invention provide methods and computer implemented systems that enable segmentation of advertising inventory for an advertisement campaign based on advertisement campaign requirements. A plurality of campaign requirements that include a descriptive tag and campaign objectives for an advertisement campaign are captured and used in analyzing a tag inventory. The tag inventory is analyzed using the descriptive tag of the ad campaign, by a proposal optimization tool. The descriptive tag is a set of keywords or phrases that capture the campaign requirements and is used as an index to identify bookings within the tag inventory. The tag inventory is a repository of past advertisement campaigns associated with a plurality of advertisers and includes plurality of descriptive tags and plurality of bookings associated with one or more of the descriptive tags. The inventory of bookings in the tag inventory includes bookings associated with both host network advertisement campaign and affiliates network advertisement campaign. During the analysis, the tag inventory is filtered based on the campaign requirements. The optimization tool identifies and presents one or more bookings that match the descriptive tag or at least a portion of campaign requirements. The identified bookings may be further refined based on a response received to the presented bookings. A media plan that includes some or all of the identified bookings is finalized based on the campaign requirements and objectives. The media plan thus generated makes optimal use of the advertising inventory while meeting the advertisement campaign objectives.

The benefits of the invention are numerous. The embodiments of the invention provide a more interactive approach for an advertiser or a planner in planning an appropriate type of campaign to use in order to obtain optimal result for an advertisement product. Additionally, the embodiments of the invention make searching the distributed inventory more intuitive, easy and fast. Using the proposed method, under-utilized inventory are managed in a more efficient manner. The proposed method helps improve performance of future advertising campaigns based on insights obtained from historic campaign data.

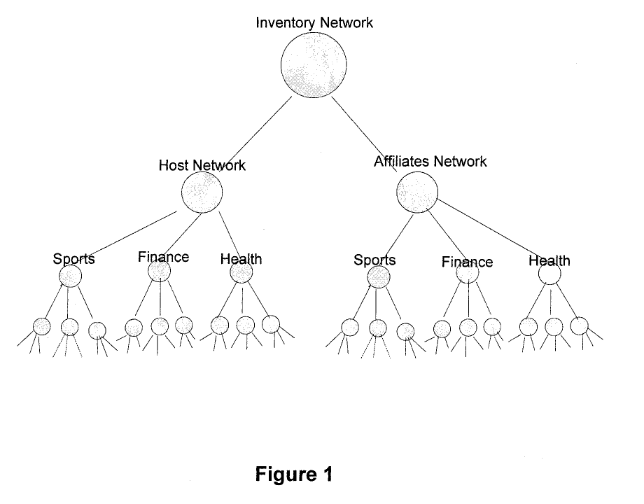

FIG. 1 illustrates a schematic representation of an Inventory network used in generating a media plan for an advertising campaign, in one embodiment of the invention. As shown in FIG. 1, the Inventory network is represented as an inventory “tree” and includes a host network and an affiliates network. The host network includes advertisement inventory that is owned and operated by a host, which also hosts a proposal optimization tool used in segmenting the inventory. The affiliates network includes advertisement inventory that is owned and operated by a plurality of affiliates and accessible by the host through a computer network, such as an internet. The affiliates network represented in FIG. 1 may, in turn, be composed of a plurality of affiliates network hosted on a plurality of servers and accessible from a host through the internet. The affiliates may use the host resources for their respective advertisement campaign through a contract agreement. Inventory, as used in this application, is advertisement inventory that includes a plurality of descriptive tags and a plurality of advertisement bookings (proposals) for previously defined advertisement campaigns associated with one or more of these descriptive tags. Booking, as used in this application, is defined as an advertisement line that provides details for the placement of an online advertisement.

Continuing with FIG. 1, each of the networks (host and affiliates) may be categorized based on a topic, such as Sports, Finance, Health, etc. Each of the main categories of the inventory may be further categorized into sub-groups and each of the sub-groups may be further categorized and so on. In order to provide a comprehensive media plan it is essential to traverse the length and breadth of the inventory tree to identify bookings that match the descriptive tag or at least partially match portions of campaign requirements.

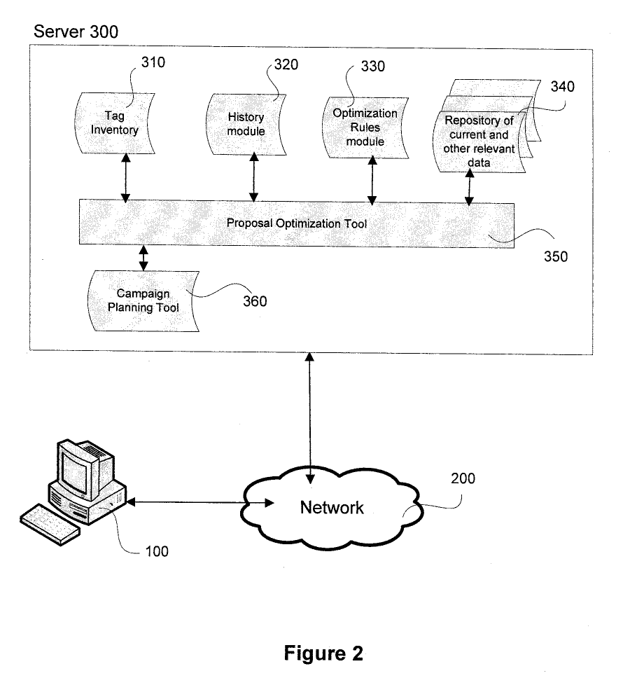

FIG. 2 illustrates a high level architecture of various functional elements of a computing system used in developing a comprehensive media plan, in one embodiment of the invention. The computing system includes a user interface 100 to capture and display campaign requirements for an advertisement (ad) campaign. The user interface 100 is communicatively connected to a server 300 through a computer network 200, such as an Internet. The connection may be wired or wireless. The server 300 includes a proposal optimization tool 350 that is used to generate a media plan for an advertisement campaign based on the campaign requirements. In order to provide a comprehensive media plan, the proposal optimization tool (optimization tool) 350 is communicatively connected to a plurality of repositories that store data relevant to the creation of the media plan. In one embodiment, the plurality of repositories include a tag inventory 310 that stores a plurality of descriptive tags and a plurality of bookings associated with one or more descriptive tags of past campaigns; a history module 320 that stores a plurality of media plans of past advertisement campaigns; an optimization rules module 330 to store a plurality of optimization rules that may be used in further refining a proposed media plan, and a repository for current inventory and other relevant data 340. In addition to the historical data with reference to past media campaigns, the history module 320 also includes comprehensive results for each of the corresponding prior campaign media plans. The comprehensive results data may provide sufficient supporting data, such as success metrics, to support a proposed media plan based on past performance.

The current inventory and other relevant data may be stored in a single repository or may be stored in a plurality of repositories each of which is communicatively connected to the proposal optimization tool to provide relevant data to the optimization tool 350 for generating a media plan. The plurality of repositories may be on the same server 300 that is hosting the optimization tool 350 or may be distributed across different servers and accessed by the optimization tool 350 through the Internet.

The repository for current inventory and other relevant data 340 may include plurality of sources, such as an inventory management system for providing data related to inventory forecasts and current availabilities, order management system for providing data related to current and historic campaign information, advertisement statistics system (Ad stats) for providing campaign related data such as click through rates, unique users etc; a pricing module for providing current price related data for building an advertisement campaign, and a reporting module for providing other metrics such as popularity, constraints etc. of various bookings so that an appropriate comprehensive media plan that meets the campaign objective can be generated.

In addition to the repositories, the optimization tool 350 is configured to interact with a campaign planning tool (CPT) 360 to receive the campaign requirements, define descriptive tags, search advertising inventory and build an appropriate advertisement campaign based on the campaign requirements. The CPT 360 is used to create and manage advertising proposals or media plans. These media plans are usually generated by Sales Planners to meet campaign objectives communicated by advertisers (customers). The campaign objectives may be communicated in client meetings or as requests-for-proposals (RFPs) or through emails, etc. The optimization tool 350 may be integrated with the CPT 360 and provide logic for the generation of media plans.

Using the optimization tool 350, an advertiser (customer) may be presented with a refined media plan that may work better than an advertisement campaign the advertiser is currently running. As the media plan is generated based on the knowledge obtained from prior advertisement campaigns and from all relevant current inventory, the proposed media plan utilizes the available inventory in a very effective manner including under-utilized and often over-looked inventory while meeting the customer's advertisement objectives.

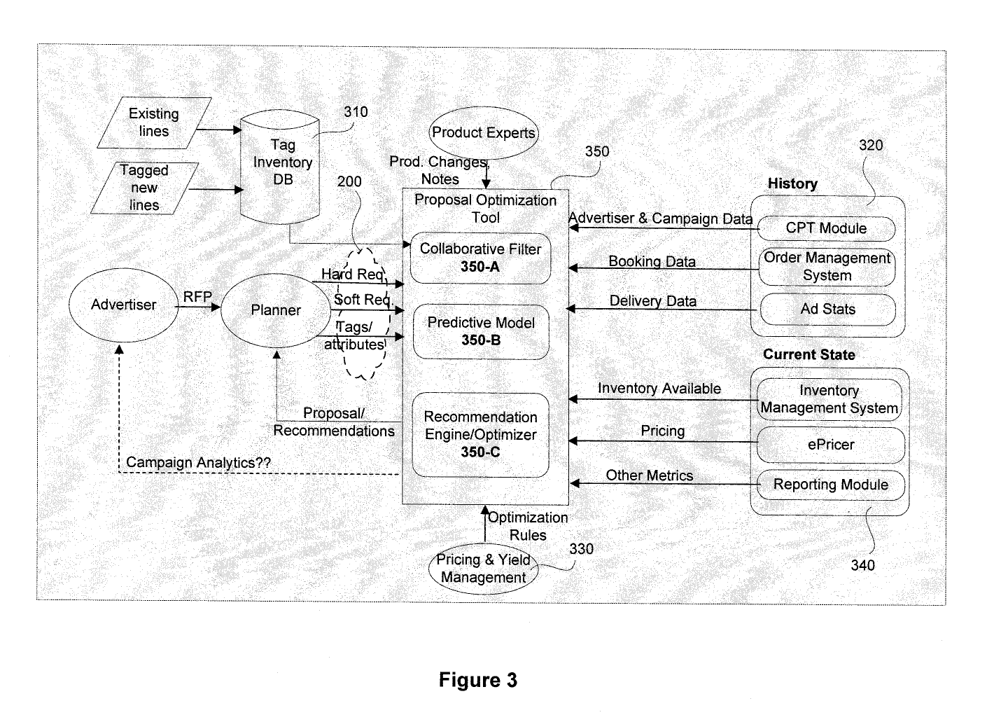

FIG. 3 illustrates a detailed architecture of various functional elements of a computing system described with reference to FIG. 2, in one embodiment of the invention. The system includes a user interface 100 that allows an Advertiser to provide a plurality of campaign attributes and campaign objectives for an ad campaign, in the form of a plurality of campaign requirements. As mentioned earlier, these advertisement requirements may be in the form of a Request-for-Proposal (RFP). Other forms of receiving advertisement requirements may include emails, client meetings, etc. The campaign requirements may be ranked and prioritized by a Sales Planner based on the campaign objectives. In cases where more than one campaign objective is provided, the Sales Planner is allowed to rank and prioritize the campaign objectives.

In one embodiment, a Sales Planner may interpret a request for an advertisement campaign from an advertiser into a plurality of campaign requirements. The campaign requirements are then converted into a plurality of hard and soft requirements by the Sales Planner using an optimization tool 350 or by a campaign planning tool 360 with the optimization tool 350 integrated within, that is communicatively connected to the user interface 100. The hard requirements may include one or more of advertiser, advertiser category, product being advertised, type of campaign, campaign descriptor, campaign budget, impressions, average cost per thousand impressions (CPM), preferred Ad units or lines, preferred context and content of the Ad (health, finance, sports, etc.), preferred roadblocks, audience composition (demographics, geographic and psychographics), degree of difference from prior campaign, degree of similarity from prior campaign, minimum and maximum number of placement, mix of guaranteed and un-guaranteed placements, campaign dates, reach, campaign goals, campaign begin date, campaign end date. The soft requirements may include one or more of number of desired clicks, desired success metrics, number of unique users, etc.

In addition to the campaign requirements, one or more campaign descriptors may also be provided. The campaign descriptors (descriptive tag) include keywords that may describe the advertiser's objectives for the ad campaign and may be used as indices to identify bookings within a tag inventory. The campaign requirements may define an advertiser's campaign objective including a target audience or information related to advertisement placement, etc., and the descriptive tag may summarize the campaign requirements using one or more keywords. For instance, an advertiser might want to place an advertisement for a beer and the advertiser's objective is to target young, male adults between ages 21-25. The campaign requirements may include young adults, beer drinkers, between ages 21-25, males, etc. In this instance, the keywords defining the descriptive tag may include “Young adults” or “Young beer drinkers.” It should be noted that the above campaign requirements are not restricted to advertising a single product but could be used by different advertisers to market a plurality of products. For instance, an advertiser trying to promote an action movie might target the same young male audience that a beer advertiser targets. In another instance, an advertiser trying to market a fabric cleaner might define his/her target audience as young women with children. In this instance, the campaign requirements may include young female adults with young children involved in sports, and the descriptive tag may be defined by the keywords “Soccer Moms.” In another instance, the campaign objective might be to capitalize on the pricing of an advertisement product and the campaign requirements may include attributes that identify the placement of other advertised products within a certain price range, placement of products that are similar in type as the target product, etc., in order to determine appropriate placement of the advertisement product. For example, the campaign requirements may include identifying placement of other advertised products that are priced less than $50.00 or identifying placement of products that are related to sports, etc., in order to determine appropriate placement of an advertisement for a golf club priced at $45.00. In this instance, the descriptive tag may be defined by the keywords “Golf Club special”. In addition to the target placement, the campaign requirements to market the golf club may include target audience of middle-age men, etc.

The descriptive tag may be configured at the time of booking an advertisement (ad) campaign when campaign requirements are provided in a booking request or after the booking of the ad campaign and indicates what the advertiser's campaign objectives are for the purchase of an ad campaign. In one embodiment, during the time of booking an ad campaign, a plurality of descriptive tags that are already available within a tag inventory 310 may be presented at the user interface by the optimization tool 350 and one of the descriptive tags that define the advertiser's campaign objective may be selected. In one embodiment, the descriptive tag is provided by the advertiser or the sales person.

In addition to the advertiser and sales person, a product expert may interact with the proposal optimization tool 350 through the user interface 100 to convey product changes and provide other notes relevant to the optimization tool 350 for performing optimization. A product expert is someone who has knowledge of the various advertising products that a particular advertiser has to offer or has knowledge of a particular product line. The product expert may in certain instances update the product information based on the availability of a particular product. For instance, when a new version of an existing product is available, the product expert may update the relevant advertising product on the system using the proposal optimization tool. The newer version may be provided as an alternate option to an existing product or as a replacement for the existing product. Upon updating the system with the new product information, the product expert may add tags related to the existing product to the new product so that the new product may be used in future optimization.

In one embodiment of the invention, the user interface 100 interfaces with a campaign planning tool (CPT) 360 to transmit the plurality of campaign requirements and the descriptive tag(s). In one embodiment, the advertiser uses the user interface 100 to directly interact with the CPT 360 to provide the campaign requirements. In another embodiment, the advertiser forwards the campaign requirements to the sales planner in the form of an RFP, e-mail or client meeting, and the sales planner interacts with the CPT 360 through a network 200. Upon receipt of the campaign requirements and/or campaign descriptors, the CPT 360 interacts with a proposal optimization tool (optimization tool) 350 to obtain relevant bookings based on the descriptive tag and/or the plurality of campaign requirements. The optimization tool 350 analyzes a tag inventory by filtering the tag inventory based on the campaign requirements. The tag inventory 310 is stored in a tag inventory database that is communicatively connected to the optimization tool 350 and includes existing campaign lines associated with past campaigns and new campaign lines. In one embodiment, the tag inventory may be analyzed based on the campaign descriptor and a recommended suggestion of bookings that match the campaign descriptor are identified. In another embodiment, the tag inventory may be analyzed to identify suggestion of bookings that match at least a portion of the plurality of campaign requirements. In this embodiment, the optimization tool 350 may correlate a plurality of campaign attributes associated with prior advertisement campaigns of a plurality of advertisers to identify the recommended suggestion of bookings. The suggestion of bookings can be seen as the most relevant bookings from the whole product offering that satisfy the campaign requirements. Once the recommended suggestion of bookings are finalized into a media plan, the identified bookings may be “tagged” with the descriptive tag(s) and stored in the tag inventory along with the descriptive tag so that future mining of these bookings is possible. The descriptive tags act as indices to the tag inventory and help in faster identification of the appropriate bookings.

The optimization tool 350 includes a plurality of modules to receive the campaign requirements, analyze available booking inventory and propose a media plan based on the campaign requirements. In one embodiment, the optimization tool 350 includes a collaborative filter 350-A, a predictive Model 350-B and a recommendation engine (optimizer) 350-C. The collaborative filter 350-A is the core analytical module that mines past campaign data to understand and predict each advertiser's booking patterns. In particular, the collaborative filter analyzes the history of past campaigns for a plurality of advertisers to determine which strategies and recommendations worked and which did not. For instance, the collaborative filter 350-A may look at past campaigns that advertised similar products to determine which bookings were bought by advertisers in the past to help them achieve their objective goal, which other bookings to buy aside from what actually matches the campaign requirements, which bookings not to buy based on what really worked or did not work in the past and which inventory did an advertiser buy that was not bought by others and how the advertiser fared in reaching his/her objective based on the inventory they bought and which inventory is associated with the campaign requirements and descriptive tags.

In order to identify relevant set of bookings, the collaborative filter 350-A analyzes data from various components. For instance, a history module 320 is used to obtain information about historical performance of campaigns including details of what was delivered at each ID level. The history module 320 may include data from a CPT module 360, which provides advertiser and campaign data in the form of campaign requirements relevant to creating an ad campaign. Aside from the data from the CPT module 360, the history module 320 may include an Order Management System to provide information related to past campaigns; and an ad stats module to provide success metrics information of past campaigns including success metrics at a booking line level. Based on the analysis, the collaborative filter 350-A returns a set of bookings that match the descriptive tag associated with one or more campaign attributes defining the campaign requirements.

The predictive model 350-B is the core of the proposal optimization tool 350. The predictive model 350-B is used to identify specific attributes to recommend for optimal advertisement campaign performance based on information about past campaigns received from the collaborative filter 350-A. In order to predict an effective campaign, the predictive model 350-B collaborates with historical data of past campaigns associated with both host and affiliates' to determine details of historical delivery of past campaigns including what was delivered at the line item level, success metrics including click through rates (CTRs), segmentation of inventory for various campaigns, inventory booking, error-rate of booking predictions in the past, cancellation rate of bookings, etc. For instance, the predictive model 350-B may include logic to determine some performance variables such as targeting or position or property profile of past campaigns, profile variation by advertiser and product category, seasonal versus trend profile variation, etc. The predictive model 350-B combines the historical campaign information with the relevant bookings received from the collaborative filter to arrive at predictive model data of what will work or will be effective for a future or proposed ad campaign.

The recommendation engine (optimizer) 350-C is a tuner module that further filters the predictive model data by inventory availability, current pricing, campaign objectives and yield management business rules. The optimizer 350-C interacts with a plurality of modules such as an ePricer module to obtain current pricing information, an Inventory Management System to obtain information about current available campaign inventory for each product or service, a Pricing and Yield Management (PYM) module 330 to obtain optimization rules, a reporting module that provides data related to popularity, constraints, etc of various bookings in the tag inventory and combines the data obtained from these aforementioned modules with results obtained from the predictive model 350-B to arrive at a recommended suggestion of alternative proposals (bookings) for the advertiser/sales planner to choose from and/or modify. The recommended suggestion of alternative proposals may be rank ordered based on the ranking order of campaign objectives and campaign requirements. For instance, in order to aggressively market a particular advertisement product, the optimization tool may weigh the appropriate campaign attributes of the product so that the campaign attributes can be appropriately ranked and prioritized in the recommended suggestion of bookings.

Upon finalization (i.e. approval) of one or more bookings from the recommended suggestion of bookings generated by the recommendation engine, a media plan is generated to include the approved bookings. Each of the approved bookings within the media plan may be turned into an Insertion Order (IO). The IO provides the details for booking line-level details. Insertion Order, as used in this application, is defined as a formal, printed or finalized order to run an ad campaign. Typically, the insertion order includes a plurality of campaign requirements such as campaign name, an internet site or host site that is receiving the IO, the planner or advertiser giving the order, individual ads to be run, the ad sizes, the campaign beginning and campaign end dates, total cost, discounts to be applied, cost per thousand impressions (CPM), reporting requirements and possible stipulations relative to the delivery of the impressions.

The optimization rules that may be used in finalizing the recommended suggestion of bookings include business rules implemented by a host within the Optimizer 350-C. The optimization rules may be used to select appropriate inventory of bookings from similarly ranked or weighted bookings. For instance, during the analysis phase, if a pair of bookings with different placement suggestions match the campaign requirements equally, meaning that the two bookings with different placement suggestions are “equally effective”, then the optimization rules within the Optimizer 350-C may recommend the booking that includes the least-utilized placement suggestion while generating the recommended suggestion of bookings in order to maximize the yield of available inventory. Similarly, if two bookings with different placement suggestions are equally effective then the optimization rules may recommend the booking that has a better cost per thousand impressions (CPM) placement suggestions. Impression, as used in this application, is defined as a count of delivered basic advertising unit (ad line) from an advertisement distribution point, such as a host. The standard cost for placing most of the online advertising are sold as CPMs. In another instance, the optimization rules may maximize remaining inventory availability by recommending as little inventory as possible. The optimization rules may further provide maximum delivery flexibility by recommending as many placements at Run-of-Network (RON) or Run-of-Property (ROP). RON ad is defined as one that is placed to run on all sites within a given network of sites. The optimization rules may further provide maximum placement “diversity” by allowing increased number of placements relative to previous campaigns. The business rules may be further driven by policy that may provide limitations such as maximum number of lines on an insertion order, minimum impression threshold for a line, maximum number of targets on a line, etc. The various optimization rules are used in filtering the set of bookings presented by the collaborative filter 350-A.

The key to defining an optimal media plan is to capture campaign descriptors, campaign objectives and campaign requirements when creating an advertisement campaign. These campaign descriptors (descriptive tags) are used as index to uniquely identify an advertisement campaign within the tag inventory. It should be noted that the Optimization tool 350 may include logic to recognize and understand conceptual semantics when found in the descriptive tags to define similar elements and to standardize these semantics. For example, the optimization tool 350 should be able to understand that “a car” and “an automobile” are conceptually referring to the same item. Additionally, the Optimization tool may include logic to normalize the tags in order to avoid duplication of descriptive tags.

The Optimizer module 350-C presents the recommended suggestion of bookings that match the campaign descriptor or are associated with the campaign requirements at the user interface 100 and receives a response to the presented bookings through the user interface 100. In one embodiment, the response received may include selection of one or more bookings that match the descriptive tag or at least a portion of the advertisement campaign requirements. A media plan is generated with the selected bookings that meet the campaign objectives. In another embodiment, the response may include tweaking of one or more campaign attributes including the descriptive tag to further refine the analysis of the tag inventory. In this case, one or more campaign attributes are received at the Optimizer module 350-C. The Optimizer module 350-C in conjunction with the Predictive model 350-B will perform further analysis of the tag inventory to filter the available bookings into segments based on the refined set of campaign requirements. The Optimizer module 350-C then identifies a recommended suggestion of one or more bookings that match the refined campaign requirements and presents the recommended suggestion of bookings at the user interface 100. One or more of the identified bookings may be selected from the recommended suggestion of bookings to generate a media plan that meets the campaign objective(s). This may include bookings that match either the descriptive tag or one or more campaign requirements.

Once the media plan for the advertising campaign is finalized, the descriptive tag associated with the bookings in the finalized media plan is updated to the tag inventory by the Optimizer module 350-C. The Optimizer module 350-C further updates each of the recommended suggestion of bookings that make up the media plan with the descriptive tag so that these bookings may be identified in the future during analysis and data mining.

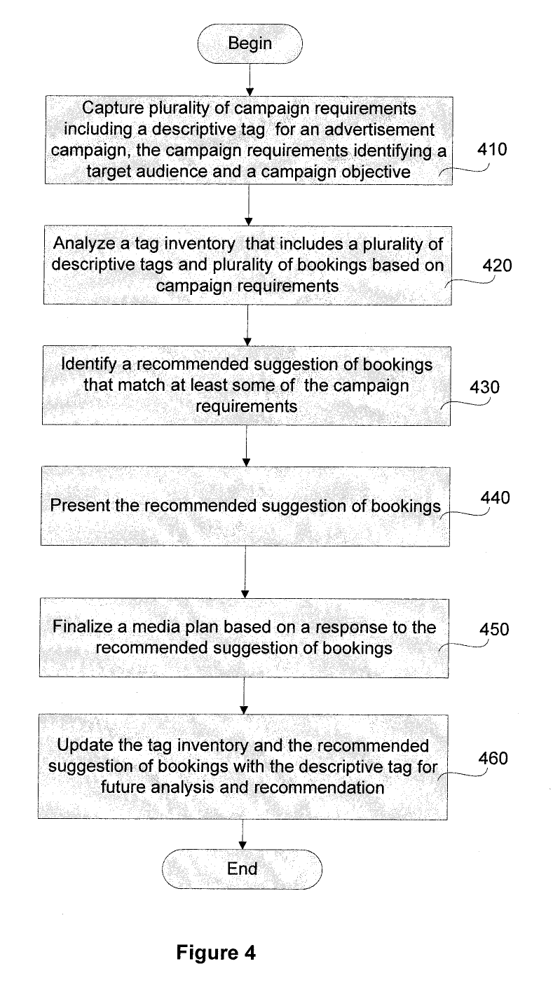

With the above detailed description of the proposal optimization tool, a method for segmenting advertising inventory for an advertisement campaign will now be described with reference to FIG. 4. The method begins when an advertiser provides a plurality of campaign requirements for an ad campaign, as illustrated in operation 410. The plurality of campaign requirements are provided in the form of campaign attributes at a user interface either by an advertiser directly or by a sales person after obtaining the campaign requirements from the advertiser through email, RFP, client meeting, etc. The campaign attributes include one or more campaign objectives and a suggested target audience for the ad campaign. The campaign attributes may be ranked and prioritized based on the campaign objectives. In one embodiment, the ranking and prioritizing of the campaign attributes are performed by the advertiser or by the sales person. In another embodiment, a set of optimization rules may be provided within the optimization tool 350 to rank and prioritize the campaign requirements based on the campaign objectives. A descriptive tag to uniquely identify the ad campaign is defined. The descriptive tag may be defined during the time of receiving the campaign requirements or after a media plan is generated. In one embodiment, the descriptive tag is defined by a Sales Planner or an Advertiser based on the various campaign requirements.

A campaign planning tool (CPT) 360 on a server 300 communicatively connected to the user interface 100 receives the campaign attributes through a network 200. The campaign attributes are forwarded to a proposal optimization tool 350 that is either integrated within the CPT 360 or is communicatively connected to the CPT 360. A tag inventory available at the server 300 is analyzed using the optimization tool 350, as illustrated in operation 420. The tag inventory includes a plurality of descriptive tags and plurality of bookings associated with one or more of the descriptive tags. The analysis is performed by filtering the plurality of bookings within the tag inventory into segments based on the campaign requirements. The filtering can be further refined based on the rank and priority of the various campaign requirements.

A recommended suggestion of bookings that match a descriptive tag or match at least some of the campaign requirements are identified by the optimization tool 350, as illustrated in operation 430. The identified suggestion of bookings is presented at the user interface, as illustrated in operation 440. The optimization tool 350 receives a response from the user interface in reply to the suggestion of bookings presented. In one instance, an advertiser or a sales person may review the recommended suggestion of bookings and may want to further tweak one or more campaign requirements to further refine the analysis or narrow the recommended suggestion of bookings to meet the advertisement campaign objective(s). In this instance, the response may include one or more campaign attributes that were already provided but now tweaked further or may include additional campaign attributes to further refine the analysis. In this instance, the optimization tool 350 receives the modified or additional campaign requirements and analyzes the tag inventory to identify a plurality of bookings that match the modified campaign requirements. The process of refining the campaign attributes and analyzing the tag inventory may continue till the campaign objective(s) is met. Upon meeting the campaign objective(s), one or more suggested bookings that meet the objectives of the campaign are selected. The selected bookings are used to finalize a media plan for the ad campaign, as illustrated in operation 450.

Upon finalizing the media plan for the ad campaign, the descriptive tag that uniquely identifies the finalized media plan is updated into the tag inventory. Additionally, the recommended suggestion of bookings that make up the media plan are updated with the descriptive tag so that these updated bookings can be used in future analysis, as illustrated in operation 460. The process concludes with the generation of the optimal media plan and the updating of the descriptive tag in the tag inventory. The updating of the descriptive tag enables faster and easier mining and recommendation of relevant bookings in the future.

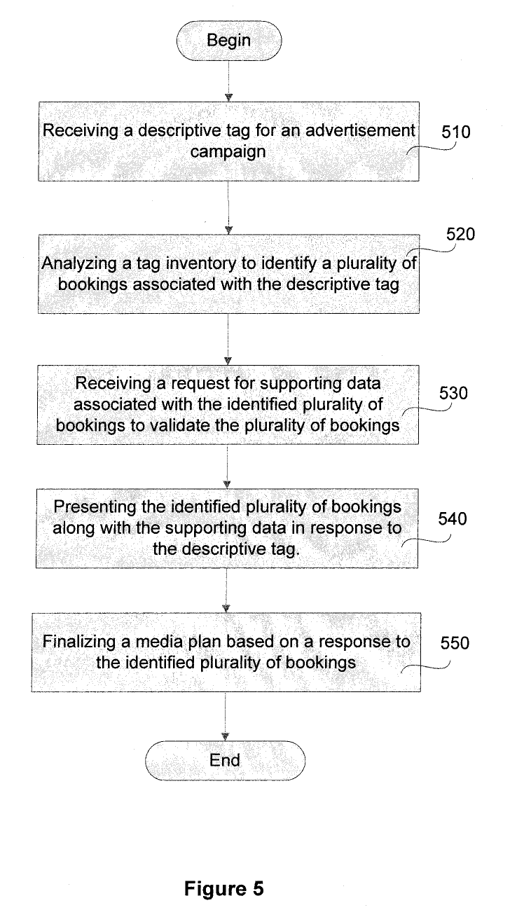

FIG. 5 illustrates flowchart of operations associated with alternate method for segmenting advertising inventory for an advertisement campaign. The method begins at operation 510 where a descriptive tag for an advertisement campaign is received at a campaign planning tool 360 on a server 300 through an user interface 100. The descriptive tag identifies target audience and/or one or more objectives for the ad campaign. The campaign planning tool 360 may include a proposal optimization tool 350 incorporated therein or may be communicatively connected to the proposal optimization tool 350 resident on the server 300.

The proposal optimization tool 350 analyzes a tag inventory of prior bookings and identifies one or more bookings that are associated with the descriptive tag, as illustrated in operation 520. The proposal optimization tool 350 may customize the search of the tag inventory to determine the prior booking patterns of an advertiser advertising similar products. The identified plurality of bookings may include latest updates to the inventory since last used by the advertiser. The plurality of bookings may be sorted based on the campaign requirements and objectives. Advanced sorting feature within the optimization tool 350 enables sorting of the plurality of bookings.

A request for additional supporting data to validate one or more of the identified plurality of bookings is received, as illustrated in operation 530. The request may be made by an advertiser and/or a Sales Planner. The supporting data requested may be a list of advertisers advertising similar product within a category/sub-category that have purchased one or more of the identified bookings and have obtained the corresponding results, etc. The advertiser and/or Sales Planner may pick and choose which supporting data needs to be included with the recommended suggestion of bookings.

The identified plurality of bookings is returned as recommended suggestion of bookings along with the associated supporting data in response to the descriptive tag and the request for supporting data, as illustrated in operation 540.

A media plan is finalized based on a response to the recommended suggestion of bookings, as illustrated in operation 550. The response may include one or more campaign attributes to further search the tag inventory for refined set of bookings that satisfy the campaign objective(s) or may be in the form of selection of one or more bookings based on the associated supportive data. When additional campaign attributes are provided, the optimization tool once again analyzes the tag inventory to identify and return the appropriate bookings that match the refined campaign attributes. The process concludes when one or more bookings are selected. The selected bookings are returned in the form of a finalized media plan for the proposed ad campaign.

The above processes provide an optimization tool that is configured to generate an optimal media plan that matches an advertiser's objective while utilizing the advertising inventory optimally. The optimization tool captures a plurality of keywords (descriptive tags) that uniquely identify the media plan and uses this as an index to efficiently mine the tag inventory thereby providing a more exhaustive and faster mining of inventory. The descriptive tags enhance performance of future advertising campaigns based on insights gathered from historic data campaign. Under-utilized inventory are identified and appropriately used allowing maximization of the available inventory.

In the tag inventory, a small amount of inventory that is most popular may provide the most result. For instance, in a tag inventory graph with inventory vs revenue, about 15% of the inventory representing the head of the graph may account for about 90% of revenue while the remaining about 85% of the inventory representing the tail of the graph may account for about 10% of the revenue. As a result, in the traditional methods, when advertisers or sales people generated a media plan, they identified the inventory at the head of the inventory graph that generated 90% result ignoring the remaining tail portion of the inventory graph that generated about 10% of the result about of the inventory leading to under-utilization of inventory. The optimization tool 350 overcomes this problem by ensuring that the inventory across the entire spectrum of the tag inventory graph is considered while generating the media plan.

Further, the process provides a broader range of advertisers the flexibility to control their own ad campaign. The optimization tool 350 provides the ability to mine host owned inventory and affiliates owned inventory to provide an optimal media plan without having to rely on any one person's expertise in mining data. The recommended suggestion of bookings that make up the media plan include updated inventory. The optimization tool 350 is configured to allow periodic updating of the tag inventory to reflect changes that have occurred over time. The period for updating the tag inventory may be driven by business-rules or by the advertiser/Sales planner so that the returned inventory reflects the most up-to-date inventory data and the generated media plan the most relevant updated bookings available.

It will be obvious, however, to one skilled in the art, that the present invention may be practiced without some or all of these specific details. In other instances, well known process operations have not been described in detail in order not to unnecessarily obscure the present invention.

Embodiments of the present invention may be practiced with various computer system configurations including hand-held devices, microprocessor systems, microprocessor-based or programmable consumer electronics, minicomputers, mainframe computers and the like. The invention can also be practiced in distributed computing environments where tasks are performed by remote processing devices that are linked through a wire-based or wireless network.

With the above embodiments in mind, it should be understood that the invention can employ various computer-implemented operations involving data stored in computer systems. These operations are those requiring physical manipulation of physical quantities. Usually, though not necessarily, these quantities take the form of electrical or magnetic signals capable of being stored, transferred, combined, compared and otherwise manipulated.

Any of the operations described herein that form part of the invention are useful machine operations. The invention also relates to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

The invention can also be embodied as computer readable code on a computer readable medium. The computer readable medium is any data storage device that can store data, which can be thereafter be read by a computer system. The computer readable medium can also be distributed over a network-coupled computer system so that the computer readable code is stored and executed in a distributed fashion.

Although the foregoing invention has been described in some detail for purposes of clarity of understanding, it will be apparent that certain changes and modifications can be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A method for enabling segmentation of advertising inventory for an advertisement campaign, comprising:
receiving a plurality of campaign requirements for an advertisement campaign, the plurality of campaign requirements including a descriptive tag uniquely identifying the advertisement campaign and a plurality of campaign attributes defining the campaign requirements of the advertisement campaign including target audience and advertisement campaign objective;
analyzing a tag inventory, the tag inventory being a repository of descriptive tags of past advertisement campaigns and advertisement bookings associated with one or more of the descriptive tags, the analysis is by filtering through the plurality of bookings available in the tag inventory based on the captured descriptive tag and campaign attributes,
presenting a recommended suggestion of bookings based on the analysis, the recommended suggestion of bookings matching at least a portion of the campaign attributes; and
generating a media plan for the advertisement campaign based on a response received for the recommended suggestion of bookings, the response defining relevancy of the recommended suggestion of bookings,
wherein the descriptive tags and bookings associated with one or more of the descriptive tags define prior advertisement campaigns and the filtering providing an understanding of booking patterns related to each advertisement campaign.

2. The method for enabling segmentation of advertising inventory for an advertisement campaign of claim 1, wherein the descriptive tag is provided at the time of booking the advertisement campaign or after booking the advertisement campaign.

3. The method for enabling segmentation of advertising inventory for an advertisement campaign of claim 1, wherein the tag inventory includes bookings associated with a plurality of advertisers from both a host network and affiliates network.

4. The method for enabling segmentation of advertising inventory for an advertisement campaign of claim 3, wherein the response includes,
receiving one or more of a plurality of campaign attributes for further tuning the filtering of the tag inventory; and
refining the filtering of the tag inventory during analysis based on the campaign attributes to obtain a refined recommended suggestion of bookings from the tag inventory.

5. The method for enabling segmentation of advertising inventory for an advertisement campaign of claim 4, wherein the response includes,
selecting a booking from the recommended suggestion of bookings, the selection of the booking satisfying the campaign objective; and
updating the descriptive tag associated with the selected booking in the tag inventory for future analysis and recommendation.

6. The method for enabling segmentation of advertising inventory for an advertisement campaign of claim 5, further including assigning the descriptive tag to the recommended suggestion of bookings to enable segmentation of tag inventory during future analysis.

7. The method for enabling segmentation of advertising inventory for an advertisement campaign of claim 3, wherein the plurality of bookings, descriptive tag and advertisement requirements are weighted to enable recommendation of appropriate bookings during analysis.

8. The method for enabling segmentation of advertising inventory for an advertisement campaign of claim 3, wherein analyzing the tag inventory further including correlating the campaign requirements of the plurality of advertisers to obtain the recommended suggestion of bookings that satisfy the campaign objective.

9. The method for enabling segmentation of advertising inventory for an advertisement campaign of claim 1, wherein the campaign attributes include hard requirements and software requirements, the hard requirements including one or more of advertiser, advertiser category, product being advertised, type of campaign, campaign descriptor, campaign budget, impressions, average cost per thousand impressions, number of unique users desired, preferred Ad units, preferred contexts, preferred roadblocks, composition of target audience based on demographic, geographic and psychographic description, degree of difference from prior campaign, degree of similarity from prior campaign, minimum and maximum number of placement, mix of guaranteed and unguaranteed placements, campaign begin date, campaign end date, and soft requirements including one or more of campaign goal, number of expected clicks, number of unique users.

10. The method for enabling segmentation of advertising inventory for an advertisement campaign of claim 1, wherein analyzing a tag inventory further including:
receiving a descriptive tag defining the advertisement campaign;
presenting the descriptive tag identifying the advertisement campaign at the tag inventory; and
receiving a plurality of bookings associated with the descriptive tag, the plurality of bookings identifying one or more of the campaign requirements associated with the descriptive tag.

11. The method for enabling segmentation of advertising inventory for an advertisement campaign of claim 1, wherein the plurality of descriptive tags within the tag inventory are standardized based on conceptual semantics and wherein the bookings are normalized so as to provide optimal set of recommended suggestion of bookings to meet the advertisement requirements.

12. The method for enabling segmentation of advertising inventory for an advertisement campaign of claim 1, further including obtaining a plurality of optimization rules, the optimization rules enabling optimization of the recommended suggestion of bookings while maximizing available tag inventory, the optimization rules including rules associated with one or more of maximizing yield, maximizing remaining inventory availability, maximizing delivery flexibility and maximizing placement diversity.

13. The method for enabling segmentation of advertising inventory for an advertisement campaign of claim 12, wherein the descriptive tags and bookings associated with one or more of the descriptive tags in the tag inventory are periodically updated to reflect changes over time, the periodic update set up through a manual or an automatic process.

14. The method for enabling segmentation of advertising inventory for an advertisement campaign of claim 1, further including requesting a plurality of supporting data for the recommended suggestion of bookings to validate the recommended suggestion of bookings.

15. A system for enabling segmentation of advertising inventory for an advertisement campaign for an advertiser, comprising:
a user interface to receive and display a plurality of campaign requirements, the campaign requirements including a descriptive tag that uniquely identifies the advertisement campaign and a plurality of campaign attributes that define the campaign requirements including identifying a target audience and a campaign objective; and
a proposal optimization tool on a server, the proposal optimization tool in communication with the user interface, the proposal optimization tool configured to capture the plurality of campaign requirements for an advertisement campaign, analyze a tag inventory having a plurality of bookings based on the plurality of campaign requirements, present a recommended suggestion of bookings from the tag inventory that match at least a portion of the campaign requirements and finalize a media plan from the recommended suggestion of bookings.

16. The system of claim 15, wherein the proposal optimization tool further including,
a collaborative filter module to analyze past campaign data and to return a plurality of bookings based on one of the descriptive tag or the plurality of campaign attributes, the plurality of bookings defined by the plurality of campaign attributes that define the requirements of the advertiser;
a predictive model to understand and provide a predictive model data for the advertiser's campaign by distilling a tag inventory based on past performance and campaign requirements, the past performance identified using the descriptive tag; and a recommendation engine to combine the predictive model with a current inventory of bookings, current pricing and campaign requirements to recommend an optimal media plan, the optimal media plan including a plurality of bookings that satisfy the campaign objective of the advertiser.

17. The system of claim 16, further including a plurality of repositories to store data from a plurality of data sources associated with historical campaign and current inventory, the plurality of repositories communicatively connected to the proposal optimization tool, the plurality of repositories including a tag repository to store the tag inventory, the tag inventory including a plurality of descriptive tags and a plurality of bookings associated with one or more of the plurality of descriptive tags, the bookings including existing and new bookings.

18. The system of claim 17, further including a campaign planning tool configured to create and manage media plans, the campaign planning tool communicatively connected to the proposal optimization tool.

19. The system of claim 18, further including a Pricing and Yield management module to provide one or more optimization rules, the optimization rules applied to the recommended suggestion of bookings for obtaining an optimal media plan, the Pricing and Yield management module communicatively connected to the proposal optimization tool.

20. The system of claim 15, wherein the proposal optimization tool configured to periodically update the plurality of bookings within the tag inventory to reflect changes to the bookings over time.

21. The system of claim 15, wherein the proposal optimization tool is further configured to interact with new data sources as the new data sources become available.

22. The system of claim 15, wherein the plurality of campaign attributes includes hard requirements and soft requirements, the hard requirements including one or more of advertiser, advertiser category, product being advertised, type of campaign, campaign descriptor (keyword(s)), campaign budget, impressions, average cost per thousand impressions, number of uniques desired, preferred Ad units, preferred contexts, preferred roadblocks, composition of target audience based on demographic, geographic and psychographic description, degree of difference from prior campaign, degree of similarity from prior campaign, minimum and maximum number of placement, mix of guaranteed and unguaranteed placements, campaign begin date, campaign end date, and soft requirements including one or more of campaign goal, number of expected clicks, number of unique users.

23. A method for enabling segmentation of advertising inventory for an advertisement campaign, comprising:
receiving a descriptive tag that uniquely identifies the advertisement campaign;
analyzing a tag inventory to identify a plurality of bookings associated with the received descriptive tag, the tag inventory having a plurality of bookings associated with one or more descriptive tags;
receiving a request for supporting data for each of the identified bookings, the supporting data providing validation information pertaining to the identified bookings;
presenting the identified plurality of bookings along with the supporting data associated with the identified bookings in response to the descriptive tag; and
generating a media plan for the advertisement campaign based on a response received for the recommended suggestion of bookings, the response defining relevancy of the identified plurality of bookings.

24. The method for enabling segmentation of advertising inventory for an advertisement campaign of claim 23, wherein identifying a plurality of bookings including:
filtering the bookings within the tag inventory into segments of bookings based on the descriptive tags; and
identifying the segmented booking associated with the received descriptive tag.

25. The method for enabling segmentation of advertising inventory for an advertisement campaign of claim 23, further including periodically updating the plurality of bookings within the tag inventory to reflect changes to the bookings over time.
